(19) United States
(12) Patent Application Publication
(10) Pub. No.: US 2016/0279764 A1
(43) Pub. Date: Sep. 29, 2016

(54) Clamp

(71) Applicant: Kenneth THOMAS, Paraparaumu (NZ)

(72) Inventor: Kenneth THOMAS, Paraparaumu (NZ)

(21) Appl. No.: 14/442,634

(22) PCT Filed: Dec. 13, 2013
(86) PCT No.: PCT/NZ2013/000232

§ 371 Date: May 13, 2015

(30) Foreign Application Priority Data
Dec. 17, 2012 (NZ) 604775

(51) Int. Cl. B25B 5/16; B25B 5/10; B25B 5/02

(52) U.S. Cl. CPC B25B 5/166; B25B 5/02; B25B 5/102

(57) ABSTRACT

A clamp as shown in FIG. 1 has a bar 1 with a plurality of locking slots 5. It has an upper jaw 2 and an adjustable jaw 3. The adjustable jaw 3 is able to slide along the bar 1. The adjustable jaw 3 has a channel which receives the bar. The channel 10 has a substantially angled side part 11 and a substantially straight side part 12, these being sufficient to enable the adjustable jaw 3 to tilt into locking engagement with the slot. There is also a screw tensioner 4 which can be adjusted to apply pressure between the jaws 2 and 3.

### FIELD OF INVENTION

This invention relates to a clamp. A preferred form of the invention relates to a G style clamp, although it should be understood that the invention is not limited to this.

### BACKGROUND

Clamps can be used as fastening devices to hold objects together. One disadvantage of some clamps is that they can too readily fail when in use, with jaws of the clamp coming apart due to tension from the objects being held, with the result that the objects separate. This can arise in particular when clamped objects are subject to hammering or other vibrations. It is accordingly an object of a preferred form of the invention to go at least some way towards addressing this problem, or to at least provide the public with a useful choice.

### SUMMARY OF THE INVENTION

According to one aspect of the invention there is provided a clamp, comprising:
a bar having at least one locking slot;
a first jaw mounted or mountable on the bar;
an adjustable jaw adapted to slide along the bar, such jaw having a channel which receives the bar, the channel having a substantially angled side part and a substantially straight side part, these side parts arranged to enable the adjustable jaw to tilt into locking engagement with the slot so that a portion of the angled side part locks into the slot when the jaw is tilted into a locking engagement; and
a tensioner which can be adjusted to apply pressure between the two jaws.

Preferably, the tensioner is mounted or mountable on the adjustable jaw.

Preferably, the tensioner is mounted or mountable on the first jaw.

Preferably, the tensioner comprises a threaded shaft which is engageable with a screw thread of the adjustable jaw.

Preferably, the tensioner is substantially parallel to the bar when in a clamping disposition.

Preferably, the first jaw is substantially perpendicular to the bar.

Preferably each locking slot has a substantially triangular shape adapted to receive a portion of the angled side.

Preferably, the first jaw is mounted or mountable adjacent to one end of the bar.

Preferably, the bar has a plurality of locking slots.

Preferably, the locking slots are angled notches that are at least 1.5 mm, at least 2 mm, at least 3 mm, at least 4 mm or at least 5 mm in depth.

Preferably, the bar has a jaw stop to prevent the adjustable jaw from disengaging the bar.

Preferably, the bar has a jaw stop to prevent the adjustable jaw from disengaging the bar.

Preferably the channel's substantially angled and substantially straight side parts are opposite one another, and there is a further angled side part next to the straight part opposite the first mentioned angled part.

Preferably the angled side parts are substantially parallel.

### BRIEF DESCRIPTION OF DRAWINGS

Some preferred embodiments of the invention will now be described by way of example and with reference to the accompanying drawings, of which:

FIG. 1 is a side view illustrating a clamp;

FIG. 2 is a side cross section view illustrating an adjustable jaw which forms part of the clamp;

FIG. 3 is a side cross section view illustrating the way the adjustable jaw associates with a bar of the clamp;

FIG. 4 is an isometric view illustrating the clamp in use;

FIG. 5 is an isometric view of a clamp according to further embodiment of the invention;

FIGS. 6a, 6b and 6c illustrate detail of affixed jaw of the FIG. 5 embodiment, shown in isometric, plan and side views respectively;

FIGS. 7a, 7b and 7c illustrate detail of an adjustable jaw of the FIG. 5 embodiment, shown in isometric, side and plan views respectively;

FIG. 8 is an isometric view of a bar forming part of the FIG. 5 embodiment; and

FIGS. 9a, 9b and 9c illustrate parts of a screw tensioner of the FIG. 5 embodiment.

### DETAILED DESCRIPTION

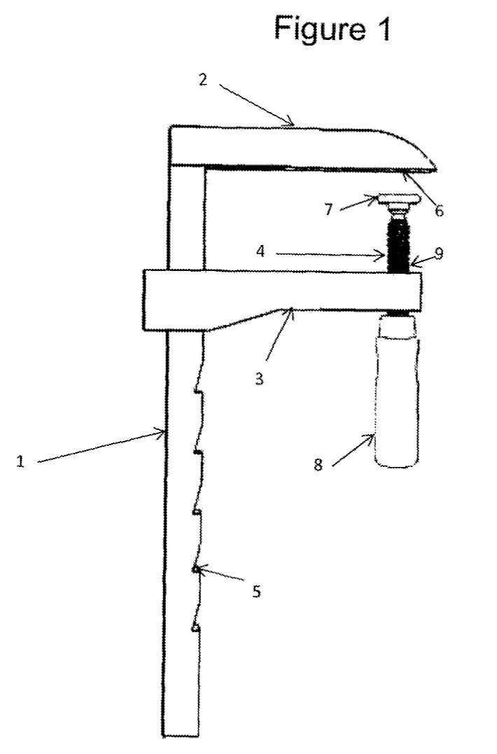

Referring to FIG. 1, the clamp has a bar 1, a fixed jaw 2, an adjustable jaw 3 and a screw tensioner 4. The tensioner 4 has a threaded shaft which engages a complimentary screw thread in the adjustable jaw. The bar 1 may, for example, comprise a pipe or other solid or hollow cylinder. The bar l can be made from a metallic substance such as steel or any other suitable material. The bar 1 may also contain a stopper (not shown) at its lower end to prevent the adjustable jaw 3 from coming off the bar. The bar 1 has a number of locking slots 5 which are located on one side of the bar 1. The locking slots 5 are approximately 3 mm deep, although in some other embodiments they may only be 1.5 mm or 2 mm deep, or more than 3 mm deep.

As shown in FIG. 1, the fixed jaw 2 is perpendicular to the bar 1. It has a surface 6 suitable for engaging an object to be clamped. The fixed jaw 2 may be made from a metallic substance such as steel or any other suitable material. In the embodiment shown the fixed jaw 2 is located at the top of the bar 1. In other embodiments it may be located in a different position.

As also indicated in FIG. 1, the adjustable jaw 3 is, when in a clamping disposition, perpendicular to the bar 1 and parallel to the fixed jaw 2. The adjustable jaw 3 can be moved to and held in place by the locking slots 5, which provide a range of clamping positions. The adjustable jaw 3 may be made from a metallic substance such as steel or any other suitable material.

As shown in FIG. 1, the screw tensioner 4 has a contact surface 7 at its upper end and a handle 8 at its lower end. Turning the handle 8 applies a screw force which causes the tensioner to move towards or away from the fixed jaw 2, depending on whether the turning force is clockwise or anticlockwise. This enables the clamp to be adjusted so that larger or smaller objects can be clamped between the fixed jaw 2 and the adjustable jaw 3, or more particularly between the fixed jaw 2 and the tensioner's contact surface 7. In some embodiments of the invention the tensioner 4 may be mounted on the fixed jaw 2 rather than the adjustable jaw 3. Even though the fixed jaw 3 may not directly engage the objects being clamped it should still be considered a jaw because, for example, it enables the contact surface 7 to engage one of the objects.

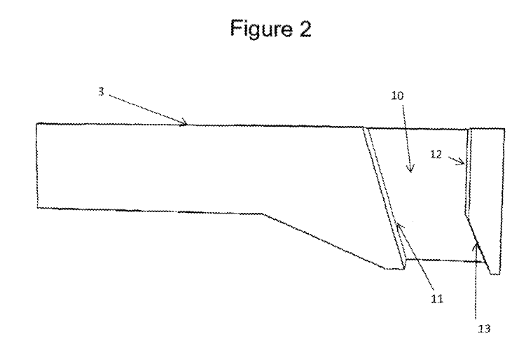

FIG. 2 shows part of the adjustable jaw 3 in more detail, and in particular the shape of an internal channel 10 of the jaw through which the bar 1 passes. The left of the channel has a long running angled side part 11 and the right of the channel has both an upper straight side part 12 and a lower short angled side part 13. When the clamp is in use it is desirable to get the fixed and adjustable jaws as close as possible together, given the item being clamped, so that the tensioner 4 does not have to be moved very far to bring about a clamping action. This is achieved by sliding the adjustable jaw 3 along the bar 1, During this sliding action the side of the bar which does not have the locking slots 5 rides along the short angled side part 13, and as it does so the jaw 3 is angled upwards rather than being perpendicular to the bar 1.

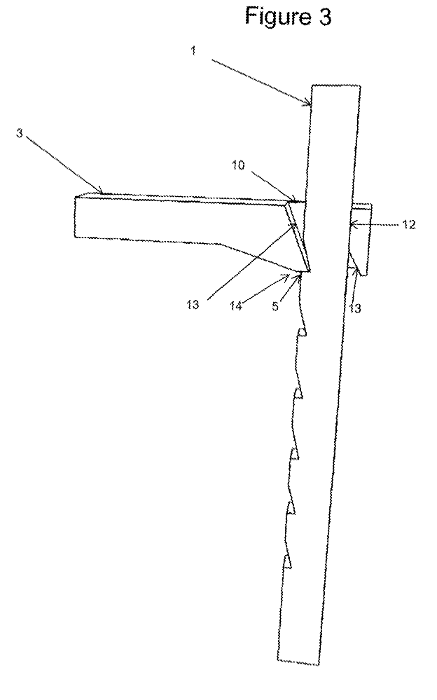

As shown in FIG. 3, when the jaw 3 is at the desired locking slot 5 it is tilted downwards so that it is perpendicular to the bar 1 and the lower edge 14 of the jaw 3 rests in and is prevented from sliding downwards by the slot 5. When in this position the right of the bar rests against the channel's straight side part 12, and part of the channel's long running angled side 11 part butts against the angle of the slot 5. The bar 1 can be released from the slot 5 by tilting it in a reverse manner to that described above.

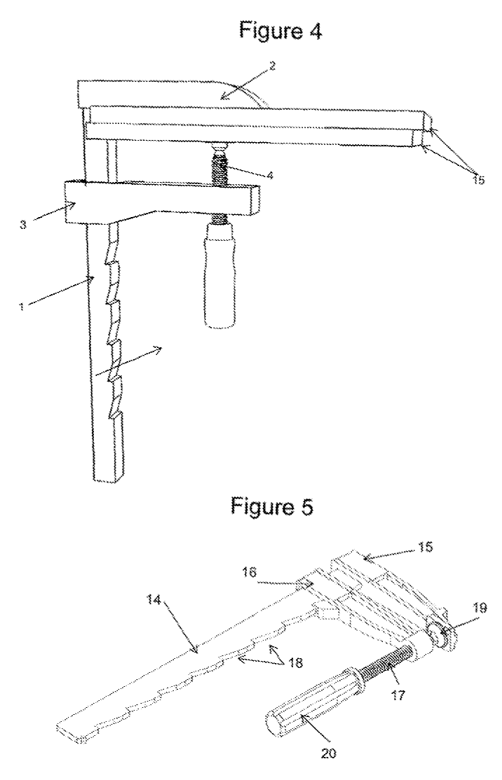

FIG. 4 illustrates the clamp when in use holding two pieces of wood 15, although the clamp can be put to a wide variety of other uses.

In other embodiments of the invention the invention both jaws may be moveable. For example the upper jaw may be moveable and able to be releasably locked in place before an object is clamped between the two jaws.

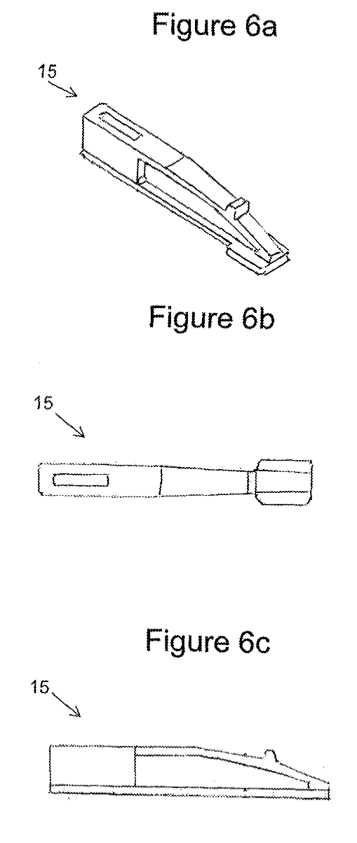

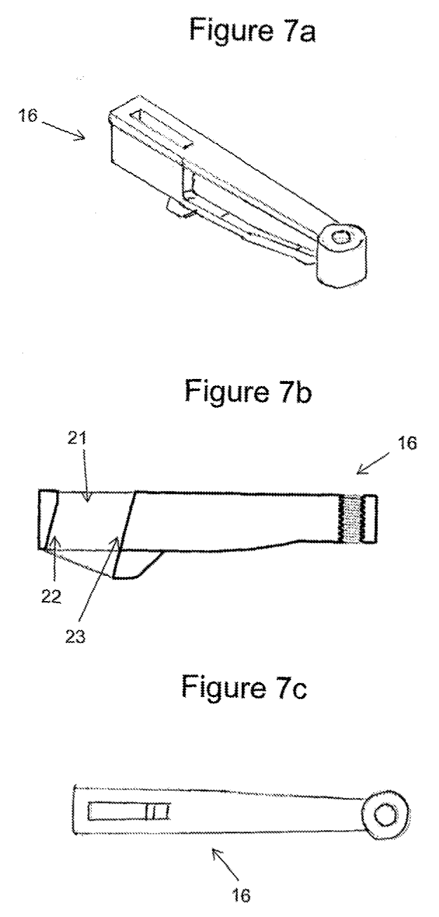

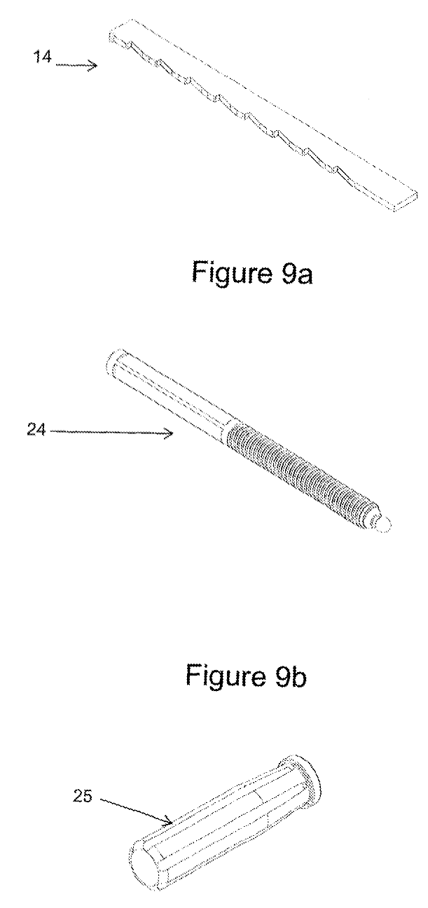

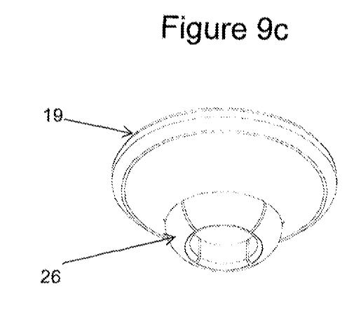

FIGS. 5 illustrates a further embodiment of the invention similar to that described above. It has a bar 14, a fixed jaw 15, an adjustable jaw 16 and a screw tensioner 17. The bar 14 has locking slots 18 on one side. The screw tensioner 17 has a contact surface 19 at its upper end and handle 20 at its lower end. All of these parts function in the same manner described for the corresponding parts of the FIG. 1 embodiment. FIGS. 6a, 6b and 6c show detail of the fixed jaw 15, FIGS. 7a, 7b and 7c show detail of the adjustable jaw 16, FIG. 8 shows detail of the bar 14 and FIGS. 9a, 9b and 9c show detail of the screw tensioner 17.

With particular reference to FIG. 7b, the adjustable jaw 16 differs a little to the corresponding part of the FIG. 1 embodiment in that its internal channel 21 is shorter on one side compared to the other. As can be seen, its long running angled side part 23 extends further than the opposite side 22 which has straight and angled surfaces.

Referring to FIGS. 9a, 9b and 9c, the screw tensioner 17 is assembled from a screw threaded rod 24, a handle 25 which engages one end of the rod 24, and a swivelling head 26 which engages the other end of the rod 24 and serves as the contact surface 19. The swivelling ability of the contact surface 19 makes it more convenient to use for clamping some objects.

While some preferred embodiments of the invention have been described by way of example it should be appreciated that modifications and improvements can occur without departing from the scope of the following claims.

1. A clamp, comprising:
a bar having at least one locking slot;
a first jaw mounted or mountable on the bar;
an adjustable jaw adapted to slide along the bar, such jaw having a channel which receives the bar, the channel having a substantially angled side part and a substantially straight side part, these side parts arranged to enable the adjustable jaw to tilt into locking engagement with the slot so that a portion of the angled side part locks into the slot when the jaw is tilted into a locking engagement; and
a tensioner which can be adjusted to apply pressure between the two jaws.

2. A clamp according to claim 1 wherein the tensioner is mounted or mountable on the adjustable jaw.

3. A clamp according to claim 1 wherein the tensioner is mounted or mountable on the first jaw.

4. A clamp according to claim 1, wherein the tensioner is mounted or mountable on the adjustable jaw and comprises a threaded shaft which is engageable with a screw thread of the adjustable jaw.

5. A clamp according to claim 1 wherein the tensioner is substantially parallel to the bar when in a clamping disposition.

6. A clamp according to claim 1 wherein the tensioner is substantially parallel to the bar when in a clamping position and the first jaw is substantially perpendicular to the bar.

7. A clamp according to claim 6 wherein the first jaw is mounted or mountable adjacent to one end of the bar.

8. A clamp according claim 1 wherein the adjustable jaw can, when engaged with the bar, tilt between a substantially perpendicular disposition and a substantially angled disposition with respect to the bar.

9. A clamp according to claim 8 wherein the bar has a plurality of similar locking slots.

10. A clamp according to claim 9 wherein each locking slot has a substantially triangular shape adapted to receive a portion of the angled side.

11. A clamp according to claim 8 wherein the or each locking slot is at least 1.5 mm deep.

12. A clamp according to claim 8 wherein the or each locking slot is at least 2 mm deep.

13. A clamp according to claim 8 wherein the or each locking slot is at least 3 mm deep.

14. A clamp according to claim 8 wherein the or each locking slot is at least 4 mm deep.

15. A clamp according to claim 8 wherein the or each locking slot is at least 5 mm deep.

16. A clamp according to claim 1 wherein the bar has a jaw stop to prevent the adjustable jaw from disengaging the bar.

17. A clamp according to claim 1 wherein the channel's substantially angled and substantially straight side parts are opposite one another, and there is a further angled side part next to the straight side part opposite the first mentioned angled part.

18. A clamp according to claim 17, wherein the angled side parts are substantially parallel.

19. (canceled)

20. (canceled)
